(19) United States
(12) Patent Application Publication
(10) Pub. No.: US 2015/0280177 A1
(43) Pub. Date: Oct. 1, 2015

(54) METHOD FOR PROVIDING A SEALING COMPOUND ON A BATTERY CELL

(71) Applicant: Intel Corporation, Santa Clara, CA (US)

(72) Inventor: Andy KEATES, Los Gates, CA (US)

(21) Appl. No.: 14/229,530

(22) Filed: Mar. 28, 2014

(51) Int. Cl. H01M 2/02

(52) U.S. Cl. CPC H01M 2/0275; H01M 2/0217

(57) ABSTRACT

A method may provide a battery cell structure. The method may include providing a battery cell, providing a first tab and a second tab on the battery cell, and providing a sealing compound to contain the battery cell.

### BACKGROUND

1. Field

Embodiments may relate to a sealing compound on a battery cell.

2. Background

A battery pack may include one or more battery cells and a battery pouch to surround the working parts (or working components) of each battery cell. The pouch may have edges thermally bonded around its edges to seal the battery cell contained therein. The battery cell may be a lithium-ion battery consisting of an electrode assembly and an electrolyte. The electrode assembly may include a positive electrode, a separator, and a negative electrode, contained in the battery pouch. The battery pouch may be made of cast polypropylene (CPP), aluminum, nylon, and/or polyethylene terephthalate (PET).

### BRIEF DESCRIPTION OF THE DRAWINGS

Arrangements and embodiments may be described in detail with reference to the following drawings in which like reference numerals refer to like elements and wherein:

FIG. 1 shows a battery cell according to an example arrangement;

FIG. 2 shows a battery pouch surrounding a battery cell according to an example arrangement;

FIG. 3 shows a cross-section of a battery cell and a battery pouch according to an example arrangement;

FIG. 4 is a flowchart of a battery dip coating according to an example embodiment;

FIG. 5 shows a wedge shaped battery according to an example embodiment;

FIG. 6 shows an electronic device according to an example embodiment; and

FIG. 7 shows an electronic system according to an example embodiment.

### DETAILED DESCRIPTION

In the following detailed description, like reference numerals and characters may be used to designate identical, corresponding and/or similar components in differing figure drawings. Further, in the detailed description to follow, example sizes/models/values/ranges may be given although embodiments are not limited to the same. Where specific details are set forth in order to describe example embodiments, it should be apparent to one skilled in the art that embodiments may be practiced without these specific details.

A battery may be a device that generates electrical potential through a chemical reaction. A battery may be a rechargeable battery that may be restored to operation by a charging operation. Batteries may include, but are not limited to, nickel cadmium (NiCad), lithium ion (Li-ion), and other rechargeable batteries.

An electronic device may be a notebook computer, a laptop computer, a handheld computer, a tablet personal computer (PC), an ultra-mobile personal computer (UMPC), a mobile Internet device (MID), a smartphone, a personal digital assistant (PDA), a mobile terminal and/or other similar device. The electronic device may be an apparatus or an electrical system.

A battery pack may be a package of one or more battery cells. A battery pack may be used in operation of many electronic devices, include mobile computing devices.

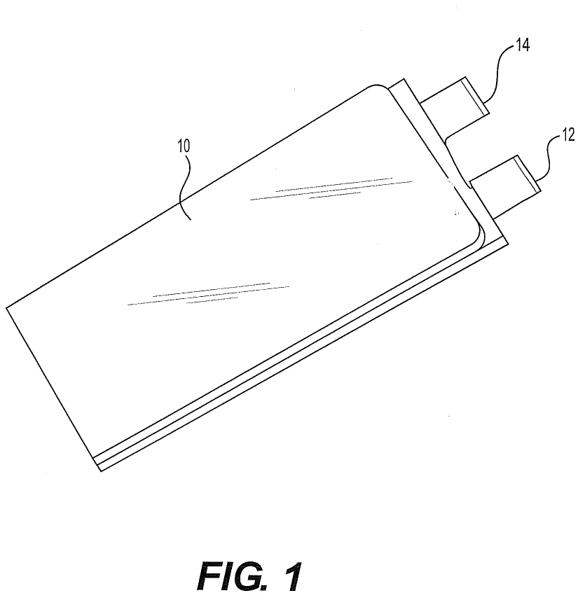

FIG. 1 shows a battery cell according to an example arrangement. Other arrangements may also be provided.

More specifically, FIG. 1 shows a battery cell 10 that has a uniform stacked cell structure (or wound cell structure). The stacked cell structure may include a number of layers of active and inactive materials to form the battery cell. A first tab 12 and a second tab 14 may be provided at one end of the battery cell structure. The first tab 12 and the second tab 14 may extend from the battery cell 10. In another arrangement, the first tab 12 may be provided at (or extend from) a first end of the structure and the second tab 14 may be provided at (or extend from) a second end of the structure opposite the first end.

The first tab 12 and the second tab 14 may provide an electrical connection between the stacked cell structure and a power source. As one example, the battery cell 10 may be provided within a battery pack of an electronic device or electronic system. The first tab 12 may electrically connect to a first electrical connector within the battery pack, and the second tab 14 may electrically connect to a second electrical connector within the battery pack.

The first tab 12 and the second tab 14 may provide power from the battery cell to the electronic device or the electronic system. The first tab 12 and the second tab 14 may also be used to charge the battery cell 10.

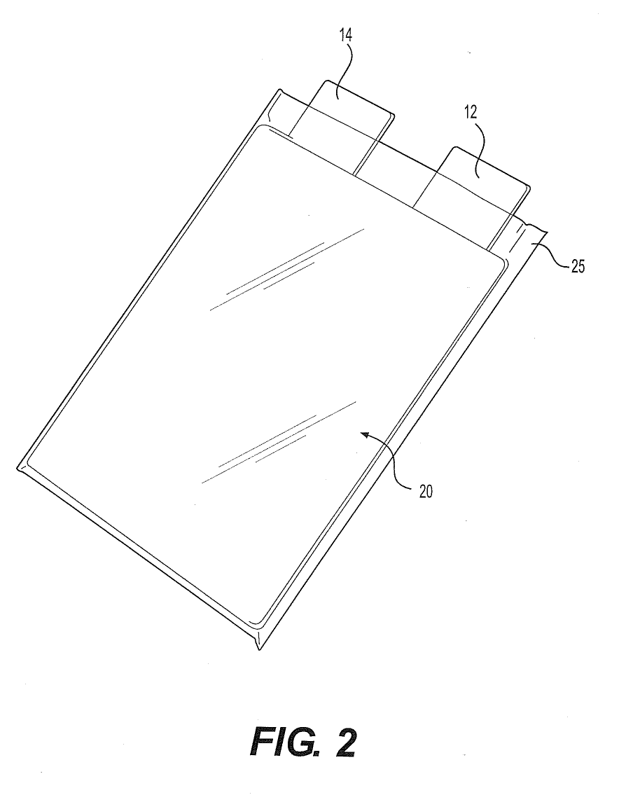

FIG. 2 shows a battery pouch that surrounds a battery cell according to an example arrangement. Other arrangements may also be provided.

More specifically, FIG. 2 shows a battery pouch 20 that substantially surrounds the battery cell 10 (or cells). This may be referred to as a battery cell structure.

The battery cell structure may include the battery cell 10 and the battery pouch 20. The battery pouch 20 may be a polymer pouch. As one example, the battery pouch 20 may be a 5-layered pouch. For example, a lithium-polymer (Li-poly cell) may be provided with a 5-layer pouch material. The 5-layer pouch material may be expensive and may be heat-sealed around edges, and the sealing area may cause additional width even when the pouch material is folded over, as shown in FIG. 2. The pouch material may contain (or hold) liquid or gel electrolyte and withstand attacks from various chemicals inside the battery pouch.

The battery pouch 20 may keep moisture out of the battery cell 10. The battery pouch 20 may also be resistant to any side reactions of the battery cell 10. The battery pouch 20 may be used when liquid or gel electrolytes are provided in the battery cell 10.

The battery pouch 20 may be folded around the battery cell and a seal may be provided along edges of the battery cell.

FIG. 2 also shows a porch 25 at one end of the battery pouch 20. The porch 25 may be heat sealed to prevent moisture from entering into the battery cell 10.

The sealed edges of the pouch may consume extra space when provided within an electronic device.

In at least one arrangement, the battery pouch may be a multilayer laminate, such as nylon, adhesive, aluminum and polypropylene. Other types of pouches may also be provided.

The battery pouch may be provided in an electronic device or an electronic system.

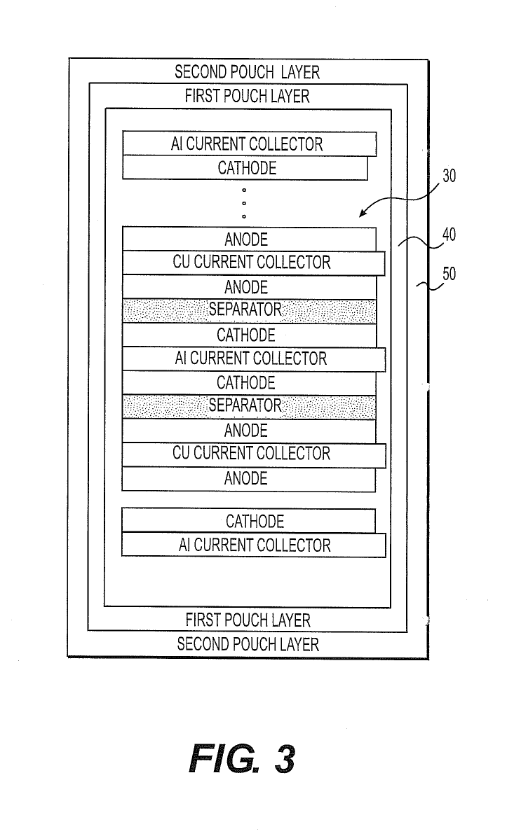

FIG. 3 shows an example of a battery cell and a battery pouch according to an example arrangement. Other arrangements may also be provided. The battery cell and the battery pouch may be provided in an electronic device or an electronic system.

FIG. 3 shows that a battery cell 30 may include numerous layers including current collector layers, cathode layers, anode layers and separator layers. In this example, the battery cell 30 may be surrounded by a pouch material. The pouch material may provide one or more layers, to form a first pouch layer 40, such as an aluminum (Al) pouch. The first pouch layer 40 may be surrounded by a second pouch layer 50, such as nylon pouch. Other types of battery pouch layers may also be provided.

When using solid electrolytes, a battery pouch may not be required to withstand a liquid electrolyte or a gel electrolyte. The outgassing of cell production may also be removed (or avoided) by using solid state electrolytes.

Embodiments may provide a method to use battery cells that do not have a caustic electrolyte (or any liquid). A sealing compound may be provided over the battery cell to withstand a chemical attack of a relatively benign solid material, rather than a liquid electrolyte. The sealing compound may also be referred to as a sealing member, a sealing coating, a skin or a shell.

Embodiments may provide a battery pouch having a reduction in demands on functionality of the pouch material. The sealing compound may be an intimate skin provided on the battery cell by spraying, dipping and/or other methodologies. The sealing compound may provide a skin to the battery cells sufficient to protect active contents from ingression of moisture or other contaminants, with sufficient mechanical strength to protect the battery cell. The battery cells may be further protected by integration of a battery pack, for example.

The sealing compound (or skin) may be applied also to a battery cell (or cells) having three dimensional shapes, such as a battery cell shaped to fit a particular cavity in a laptop (or other electronic device). The methodology of providing a sealing compound may provide flexible cell shaping, cost reduction and space saving through loss of a seam area and application of thinner coatings (as compared to demands of disadvantageous packaging material).

Embodiments may provide a battery cell structure that includes a battery cell and a sealing compound on the battery cell.

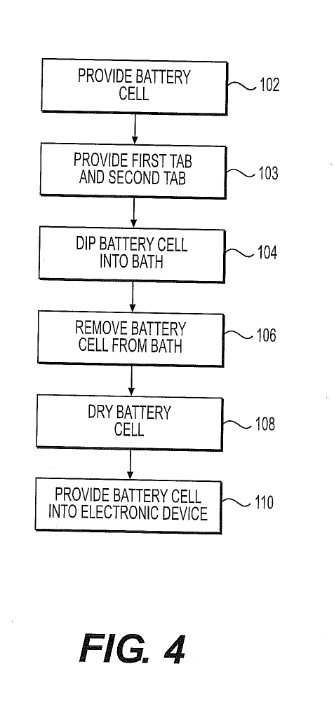

FIG. 4 is a flowchart of a battery coating operation according to an example embodiment. Other operations, orders of operation, embodiments and configurations may also be provided.

More specifically, FIG. 4 shows that a battery cell may be provided in operation 102. The battery cell may be any of a number of shapes and/or sizes.

The operation 102 may provide the battery cell. This may include providing the battery cell with solid electrolytes and/or providing the battery cell without a liquid electrolyte or a gel electrolyte. The battery cell may have a three-dimensional shape. For example, the battery cell may have a wedge shape. The battery cell may also have a varying thickness.

In operation 103, a first tab and a second tab may be provided to extend from the battery cell.

The battery cell may be dipped (or provided) into a bath in operation 104. This may provide a sealing compound around the battery cell, and thereby provide protection to the battery cell. The sealing compound may be an epoxy polymer, for example. Epoxy polymers are one example of an encapsulation material class suitable for such encapsulation, thereby providing a hermetic seal with resilience to bending of the tabs 12, 14 that conduct current into the battery cell and out of the battery cell. These materials may withstand operating temperatures of 0° Celsius to 60° Celsius (or 32° Fahrenheit to 140° Fahrenheit), and also storage temperatures of −20° Celsius to 80° Celsius (or −4° Fahrenheit to 176° Fahrenheit), for example. Any of a plurality of curing mechanisms may be provided for the epoxy polymer. The operation 104 may be referred to as a dip coating operation (or dip coating).

The operation 104 provides the sealing compound on the battery cell. This may include providing the sealing compound without providing the sealing compound on extended portions of the first tab and the second tab. The sealing compound may be an epoxy polymer, for example. The battery cell may be provided in a bath of the sealing compound. Alternatively, the sealing compound may be sprayed on the battery cell.

In operation 106, the battery cell and the sealing compound (around the battery cell) may be removed from the bath. In operation 108, the sealing compound may be cured by a variety of methods, such as chemical hardening, evaporative drying, or heating until dried. The solidified sealing compound around the battery cell may be a shell.

The sealing compound may be cured in operation 108. The curing of the sealing compound may include performing one of chemical hardening of the sealing compound, evaporative drying of the sealing compound and heating of the sealing compound.

In operation 110, the battery cell having the sealing compound (or shell) may be provided into an electronic device or an electronic system.

The above described dip coating operation may be advantageous in that a sealing compound (or shell) may be provided about (or around) the battery cell regardless of the shape or size of the battery cell. The battery cell structure may include the battery cell and the sealing compound.

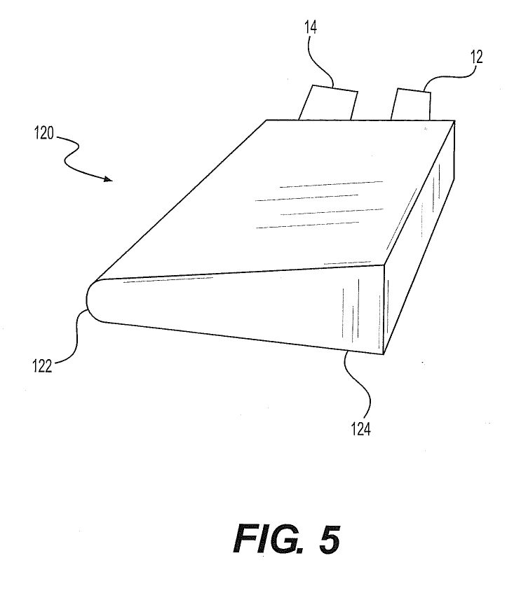

FIG. 5 shows a wedge shaped battery cell according to an example embodiment. Other embodiments and configurations may also be provided.

More specifically, FIG. 5 shows a battery cell 120 having a wedge shape with a rounded edge. The battery cell 120 may include the first tab 12 and the second tap 14 at one end of the battery cell 120 (or that extend from an end of the battery cell 120). The battery cell 120 may be different thicknesses at different locations of the battery cell. For example, as shown in FIG. 5, a thickness at a first side 122 of the battery cell 120 may be thinner than a second side 124 of the battery cell 120. Other configurations of the battery cell may also be provided.

The wedge shaped battery cell 120 may be provided with a sealing compound (or sealing coating), such as by using the operations of FIG. 4. For example, the wedge shaped battery cell 120 may be initially provided. The wedge shaped battery cell may then be dipped (or provided) into a bath in order to provide a sealing compound (or coating) around (or about) the battery cell 120. The wedge shaped battery cell 120 may then be removed from the bath, and the sealing compound (or coating) may be subsequently dried or cured. The wedge shaped battery cell 120 (having the solidified sealing compound) may then be provided within an electronic device or an electronic system.

The dip coating operation may allow differently shaped battery cells to receive a sealing compound (i.e., a shell or a coating). This may provide protection of the battery cell, such as protection from moisture.

FIG. 5 shows the wedge-shaped battery cell 120 as one example of a three-dimensional battery cell. However, other shapes and sizes of battery cells may also be used. The shapes may be determined based on a desired area of an electronic device (or an electronic system) in which to provide the battery cell. In other words, based on the electronic device (or an electronic system), a 3-dimensional battery cell may be provided with a sealing coating (or protection shell) by using a dip coating operation.

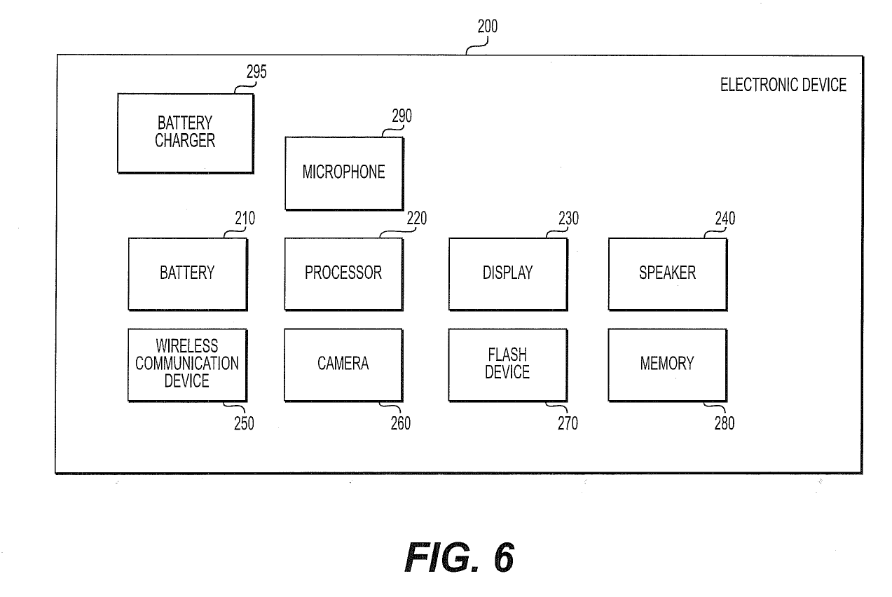

FIG. 6 shows an electronic device according to an example embodiment. Other embodiments and configurations may also be provided. The above-described battery cell structure may be provided within the electronic device shown in FIG. 6.

More specifically, FIG. 6 shows an electronic device 200 that may include any of the features, elements or operations discussed above. More or less components may also be provided.

FIG. 6 shows that the electronic device 200 may include a battery 210, a processor 220, a display 230, a speaker 240, a wireless communication device 250, a camera 260, a flash device 270, a memory 280, a microphone 290 and a battery charger 295.

The battery 210 may correspond to the above-described battery cell structure that includes the battery cell and the sealing compound.

The processor 220 may perform operations by using received instructions, such as instructions received via a computer-readable medium.

The display 230 may display an image.

FIG. 6 shows the battery charger 295 inside the electronic device 200. However, the battery charger 295 may also be provided outside the electronic device 200. The battery charger 295 may perform operations relating to charging the battery 210 and/or providing power to a load of the electronic device. The load may include any of a number of components of the electronic device.

The battery 210 (that includes the battery cell structure) may provide power to at least the processor, the display and the load.

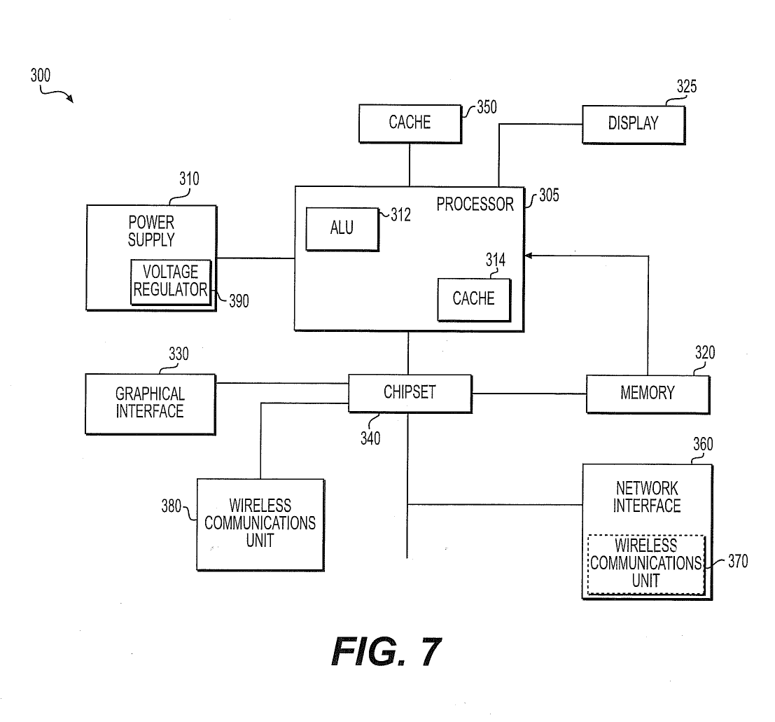

FIG. 7 shows an electronic system according to an example embodiment. Other embodiments and configurations may also be provided. The above-described battery cell structure (that includes the battery cell and the sealing compound) may be provided within the electronic system of FIG. 7.

More specifically, FIG. 7 shows a system 300 that includes a processor 305, a power supply 310, a memory 320, which may be a random access memory, for example. The electronic system 200 may also include a display 325 to display an image.

The processor 305 may include an arithmetic logic unit 312 and an internal cache 314, for example. The processor 305 may perform operations by using received instructions, such as instructions received via a computer-readable medium.

The above-described battery cell structure (that includes a battery cell and a sealing compound) may be provided as part of the power supply 310. A voltage regulator 390 may also be part of the power supply 310. In another embodiment, the above-described battery cell structure may be part of the electronics system to provide power to any of the electronic components, including at least the display and the processor.

The system 300 may also include a graphical interface 330, a chipset 340, a cache 350, a network interface 360 and a wireless communication unit 370, which may be incorporated within the network interface 360. Alternatively or additionally, a wireless communications unit 380 may be coupled to the processor 305, and a direct connection may exist between the memory 320 and the processor 305.

The processor 305 may be a central processing unit, a microprocessor or any other type of processing or computing circuit and may be included on a chip die with all or any combination of the remaining features, or one or more of the remaining features may be electrically coupled to the microprocessor die through known connections and interfaces. Also, the connections that are shown are merely illustrative as other connections between or among the elements depicted may exist depending, for example, on chip platform, functionality, or application requirements.

The following examples pertain to further embodiments.

Example 1 is a method of providing a battery cell structure comprising: providing a battery cell, providing a first tab and a second tab to extend from the battery cell, and providing a sealing compound on the battery cell.

In Example 2, the subject matter of Example 1 can optionally include that the sealing compound is an epoxy polymer.

In Example 3, the subject matter of Example 1 can optionally include providing the sealing compound includes providing the sealing compound on the battery cell without providing the sealing compound on extended portions of the first tab and the second tab.

In Example 4, the subject matter of any one of Examples 1-3 can optionally include that drying the sealing compound.

In Example 5, the subject matter of any one of Examples 1-3 can optionally include curing the sealing compound.

In Example 6, the subject matter of Example 1 and Example 5 can optionally include that curing the sealing compound includes performing one of chemical hardening of the sealing compound, evaporative drying of the sealing compound and heating of the sealing compound.

In Example 7, the subject matter of any one of Examples 1-3 can optionally include providing the battery cell having the sealing compound to an electronic device.

In Example 8, the subject matter of any one of Examples 1-3 can optionally include that providing the battery cell includes providing the battery cell with solid electrolytes.

In Example 9, the subject matter of any one of Examples 1-3 can optionally include that providing the battery cell includes providing the battery cell without a liquid electrolyte or a gel electrolyte.

In Example 10, the subject matter of any one of Examples 1-3 can optionally include that providing the sealing compound includes providing the battery cell in a bath of the sealing compound.

In Example 11, the subject matter of Example 1 and Example 10 can optionally include that providing the sealing compound includes removing the battery cell from the bath of the sealing compound.

In Example 12, the subject matter of Example 1 can optionally include that providing the sealing compound includes spraying the sealing compound on the battery cell.

In Example 13, the subject matter of any one of Examples 1-3 can optionally include that the battery cell has a three-dimensional shape.

In Example 14, the subject matter of any one of Examples 1-3 can optionally include that the battery cell has a wedge shape.

In Example 15, the subject matter of any one of Examples 1-3 can optionally include that providing the battery cell includes providing the battery cell having a varying thickness.

Example 16 is a method comprising: providing a battery cell, providing a sealing compound to contain the battery cell; and drying the sealing compound.

In Example 17, the subject matter of Example 16 can optionally include that the sealing compound is an epoxy polymer.

In Example 18, the subject matter of Example 16 can optionally include that providing the sealing compound includes providing the sealing compound on the battery cell without providing the sealing compound on extended portions of a first tab and a second tab.

In Example 19, the subject matter of any one of Examples 16-18 can optionally include providing the battery cell having the sealing compound to an electronic device.

In Example 20, the subject matter of any one of Examples 16-18 can optionally include that providing the battery cell includes providing the battery cell with solid state electrolytes.

In Example 21, the subject matter of any one of Examples 16-18 can optionally include that providing the battery cell includes providing the battery cell without a liquid electrolyte or a gel electrolyte.

In Example 22, the subject matter of any one of Examples 16-18 can optionally include that providing the sealing compound includes providing the battery cell in a bath of the sealing compound.

In Example 23, the subject matter of Example 16 and Example 22 can optionally include that providing the sealing compound includes removing the battery cell in a bath of the sealing compound.

In Example 24, the subject matter of any one of Examples 16-18 can optionally include that providing the sealing compound includes spraying the sealing compound on the battery cell.

In Example 25, the subject matter of any one of Examples 16-18 can optionally include that the battery cell has a three-dimensional shape.

In Example 26, the subject matter of any one of Examples 16-18 can optionally include that the battery cell has a wedge shape.

In Example 27, the subject matter of any one of Examples 16-18 can optionally include that providing the battery cell includes providing the battery cell having a varying thickness.

Example 28 is an apparatus comprising: a display to display an image, and a battery cell structure to provide power to at least the display, the battery cell structure including a battery cell and a sealing compound on the battery cell.

In Example 29, the subject matter of Example 28 can optionally include that the sealing compound is an epoxy polymer.

In Example 30, the subject matter of Example 28 can optionally include that the battery cell structure includes a first tab and the second tab to extend from the battery cell.

In Example 31, the subject matter of Example 28 and Example 30 can optionally include that the sealing compound is on the battery cell without providing the sealing compound on extended portions of the first tab and the second tab.

In Example 32, the subject matter of any one of Examples 28-30 can optionally include that the battery cell includes solid electrolytes.

In Example 33, the subject matter of any one of Examples 28-30 can optionally include that the battery cell is provided without a liquid electrolyte or a gel electrolyte.

In Example 34, the subject matter of any one of Examples 28-30 can optionally include that the battery cell has a three-dimensional shape.

In Example 35, the subject matter of any one of Examples 28-30 can optionally include that the battery cell has a wedge shape.

In Example 36, the subject matter of any one of Examples 28-30 can optionally include that the battery cell has a varying thickness.

Example 37 is a system comprising: a memory, a processor to perform an operation, a display to display an image, a battery cell structure to provide power to at least the processor, the battery cell structure including a battery cell and a sealing compound on the battery cell.

In Example 38, the subject matter of Example 37 can optionally include that the sealing compound is an epoxy polymer.

In Example 39, the subject matter of Example 37 can optionally include that the battery cell structure includes a first tab and the second tab to extend from the battery cell.

In Example 40, the subject matter of Example 37 and Example 40 can optionally include that the sealing compound is on the battery cell without providing the sealing compound on extended portions of the first tab and the second tab.

In Example 41, the subject matter of any one of Examples 37-39 can optionally include that the battery cell includes solid electrolytes.

In Example 42, the subject matter of any one of Examples 37-39 can optionally include that the battery cell is provided without a liquid electrolyte or a gel electrolyte.

In Example 43, the subject matter of any one of Examples 37-39 can optionally include that the battery cell has a three-dimensional shape.

In Example 44, the subject matter of any one of Examples 37-39 can optionally include that the battery cell has a wedge shape.

In Example 45, the subject matter of any one of Examples 37-39 can optionally include that the battery cell has a varying thickness.

Example 46 is an apparatus comprising: a load, means for providing power to at least the load, the means for providing including a battery cell and a sealing compound on the battery cell.

In Example 47, the subject matter of Example 46 can optionally include that the sealing compound is an epoxy polymer.

In Example 48, the subject matter of Example 46 can optionally include a first tab and a second tab to extend from the battery cell.

In Example 49, the subject matter of Example 46 and Example 48 can optionally include that the sealing compound is on the battery cell without the sealing compound on extended portions of the first tab and the second tab.

In Example 50, the subject matter of any one of Examples 46-58 can optionally include that the battery cell includes solid electrolytes.

In Example 51, the subject matter of any one of Examples 46-58 can optionally include that the battery cell is without a liquid electrolyte or a gel electrolyte.

In Example 52, the subject matter of any one of Examples 46-58 can optionally include that the battery cell has a three-dimensional shape.

In Example 53, the subject matter of any one of Examples 46-58 can optionally include that the battery cell has a wedge shape.

In Example 54, the subject matter of any one of Examples 46-58 can optionally include that the battery cell has a varying thickness.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing a battery cell structure comprising:
providing a battery cell;
providing a first tab and a second tab to extend from the battery cell; and
providing a sealing compound on the battery cell.

2. The method of claim 1, wherein the sealing compound is an epoxy polymer.

3. The method of claim 1, wherein providing the sealing compound includes providing the sealing compound on the battery cell without providing the sealing compound on extended portions of the first tab and the second tab.

4. The method of claim 1, further comprising drying the sealing compound.

5. The method of claim 1, further comprising curing the sealing compound.

6. The method of claim 5, wherein curing the sealing compound includes performing one of chemical hardening of the sealing compound, evaporative drying of the sealing compound and heating of the sealing compound.

7. The method of claim 1, further comprising providing the battery cell having the sealing compound to an electronic device.

8. The method of claim 1, wherein providing the battery cell includes providing the battery cell with solid electrolytes.

9. The method of claim 1, wherein providing the battery cell includes providing the battery cell without a liquid electrolyte or a gel electrolyte.

10. The method of claim 1, wherein providing the sealing compound includes providing the battery cell in a bath of the sealing compound.

11. The method of claim 10, wherein providing the sealing compound includes removing the battery cell from the bath of the sealing compound.

12. The method of claim 1, wherein providing the sealing compound includes spraying the sealing compound on the battery cell.

13. The method of claim 1, wherein the battery cell has a three-dimensional shape.

14. The method of claim 1, wherein the battery cell has a wedge shape.

15. The method of claim 1, wherein providing the battery cell includes providing the battery cell having a varying thickness.

16. A method comprising:
providing a battery cell;
providing a sealing compound to contain the battery cell; and
drying the sealing compound.

17. The method of claim 16, wherein the sealing compound is an epoxy polymer.

18. The method of claim 16, wherein providing the sealing compound includes providing the battery cell in a bath of the sealing compound.

19. The method of claim 18, wherein providing the sealing compound includes removing the battery cell in a bath of the sealing compound.

20. The method of claim 16, wherein providing the battery cell includes providing the battery cell having a varying thickness.
